(19) United States
(12) Patent Application Publication
(10) Pub. No.: US 2010/0062616 A1
(43) Pub. Date: Mar. 11, 2010

(54) MOTHERBOARD AND EXPANSION CARD APPLIED TO THE MOTHERBOARD

(75) Inventors: HSING-CHANG LIU, Tu-Cheng (TW); HAN-CHIEH CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/262,189

(22) Filed: Oct. 31, 2008

(30) Foreign Application Priority Data
Sep. 8, 2008 (CN) 200810304409.7

(51) Int. Cl. H01R 12/00

(52) U.S. Cl. 439/59

(57) ABSTRACT

A motherboard includes a bus, an expansion socket pair. The bus includes a number of power lines, ground lines and non-power lines. The expansion socket pair includes a first expansion socket and a second expansion socket separated from the first expansion socket. The first expansion socket includes a number of power signals pins. The second expansion socket includes a number of non-power signal pins. The power signal pins are connected to the power lines of the bus to transmit power signals. The non-power signal pins are connected to the non-power lines of the bus to transmit non-power signals.

### BACKGROUND

1. Technical Field

The present disclosure relates to computer motherboards and expansion cards, and more particularly to a motherboard and an expansion card applied to the motherboard.

2. Description of the Related Art

Generally, a peripheral component interconnect (PCI) bus is a high performance 32-bit or 64-bit bus with multiplexed address and data lines. At present, power signal pins and non-power signal pins of the PCI bus positioned on a motherboard are in a mixed arrayed in a same PCI slot, so that signal interference between the power signal pins and non-power signal pins will occur to affect the transmission of signals.

What is desired, therefore, is to provide a motherboard and an expansion card which overcome the above problems.

### BRIEF DESCRIPTION OF THE DRAWINGS

FIG. 1 is a partial schematic view of an exemplary embodiment of a motherboard.

FIG. 2 is a schematic view of an expansion card applied to the motherboard of FIG. 1.

FIG. 3 is circuit diagram of the motherboard of FIG. 1.

### DETAILED DESCRIPTION

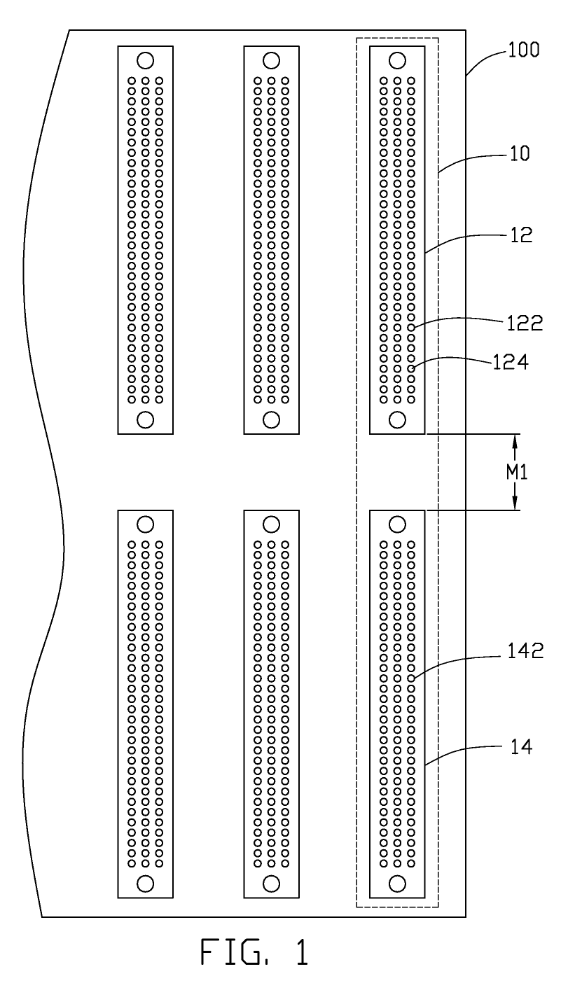

Referring to FIG. 1, an exemplary embodiment of a motherboard 100 includes a plurality of expansion socket pairs 10. Each expansion socket pair 10 includes a first expansion socket 12 and a second expansion socket 14 in alignment with the first expansion socket 12. In one embodiment, the expansion sockets 12, 14 are peripheral component interconnect (PCI) sockets. The first expansion socket 12 consists of a plurality of power signal pins 122 and a plurality of ground pins 124. The second expansion socket 14 consists of a plurality of non-power signal pins 142. The first expansion socket 12 is separated from the second expansion socket 14, with a first distance M1 formed between the first expansion socket 12 and the second expansion socket 14. In the illustrated embodiment, the first and second expansion sockets 12 and 14 both are female connectors standardized by the Deutsche Institut Fur Normung (DIN) group, the German national standards organization.

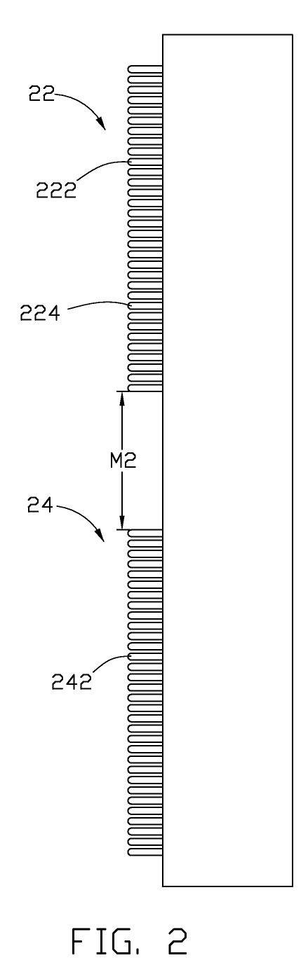

Referring to FIG. 2, an exemplary embodiment of an expansion card 20 is configured to be inserted into one of the expansion socket pair 10 of the motherboard 100. The expansion card 20 includes a first plug 22 consisting of a plurality of power signal pins 222, a plurality of ground pins 224 and a second plug 24 consisting of a plurality of non-power signal pins 242. The plurality of non-power signal pins 242 may be data signal pins, address signal pins, or control signal pins depending on the embodiment. The first plug 22 is configured to be inserted into the first expansion socket 12, to supply power for the expansion card 20 via the expansion socket pair 10. The second plug 24 is configured to be inserted into the second expansion socket 14, to communicate with the motherboard 100. The first plug 22 is separated from and aligned with the second plug 24, with a second distance M2 substantially equaling to the first distance M1 and formed between the first plug 22 and the second plug 24, to allow the expansion card 20 to be inserted into the expansion socket pair 10 so as to communicate with the motherboard 100. In the illustrated embodiment, the first plug 22 and the second plug 24 both are male DIN connectors.

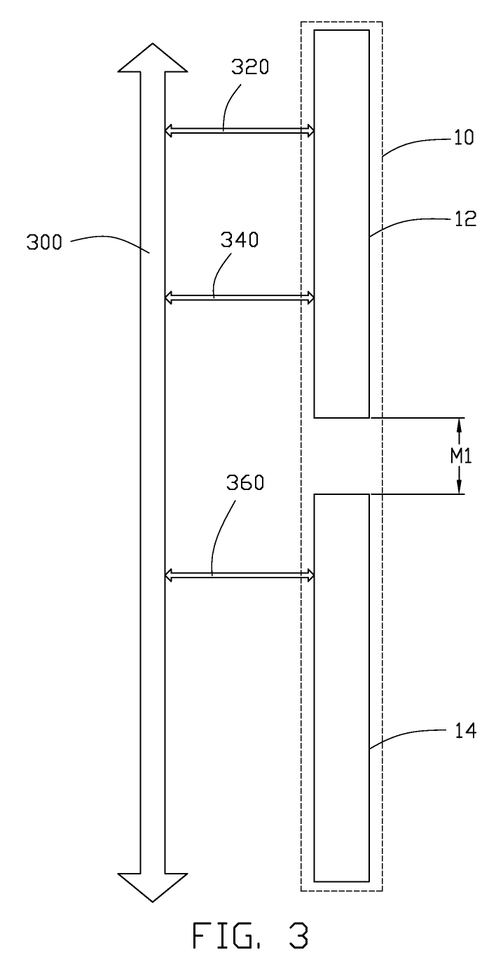

Referring to FIG. 1 and FIG. 3, the plurality of power signal pins 122 of the first expansion socket 12 are correspondingly connected to power lines 320 of a bus 300 of the motherboard 100 to receive power signals. The plurality of ground pins 124 of the first expansion socket 12 are correspondingly connected to ground lines 340 of a bus 300 of the motherboard 100. The plurality of power signal pins 222 of the first plug 22 are correspondingly connected to power lines of the expansion card 20, to receive power signals from the motherboard 100. The plurality of ground pins 224 of the first plug 22 are correspondingly connected to ground line of the expansion card 20. The plurality of non-power signal pins 142 of the second expansion socket 14 are correspondingly connected to non-power lines 360 of the bus 300 to transmit non-power signals. The plurality of non-power signal pins 242 of the second plug 24 are correspondingly connected to non-power lines of the expansion card 20 to transmit non-power signals between expansion card 20 and motherboard.

It is to be understood, however, that even though numerous characteristics and advantages of the disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A motherboard comprising:
a bus comprising a plurality of power lines configured to transmit power signals, a plurality of ground lines and a plurality of non-power lines configured to transmit non-power signals;
an expansion socket pair comprising a first expansion socket and a second expansion socket separated from the first expansion socket, wherein the first expansion socket comprises a plurality of power signals pins connected to the plurality of power lines of the bus to transmit power signals and a plurality of ground pins connected to ground lines of the bus, the second expansion socket comprising a plurality of non-power signal pins connected to the plurality of non-power lines of the bus to transmit non-power signals.

2. The motherboard of claim 1, wherein the first and second expansion sockets are peripheral component interconnection (PCI) sockets.

3. The motherboard of claim 1, wherein the first and second expansion sockets are aligned with each other, wherein a first distance is formed between the first expansion socket and the second expansion socket.

4. The motherboard as claimed in claim 1, wherein the first and second expansion sockets both are female Deutsche Institut Fur Normung (DIN) connectors.

5. An expansion card applied to a motherboard, comprising:
a first plug comprising a plurality of power pins configured to receive power signals from the motherboard; and
a second plug separated from the first plug, comprising a plurality of non-power pins configured to transmit non-power signals between the expansion card and the motherboard.

6. The expansion card of claim 5, wherein the expansion card is a peripheral component interconnect (PCI) card.

7. The expansion card of claim 5, wherein the first and second plugs are aligned with each other, with a second distance formed between the first plug and the second plug.

8. The expansion card of claim 5, wherein the first plug and the second plug both are male Deutsche Institut Fur Normung (DIN) connectors.
